(19) United States
(12) Patent Application Publication
(10) Pub. No.: US 2014/0322983 A1
(43) Pub. Date: Oct. 30, 2014

(54) Shared Ground Multiple Socket

(71) Applicant: Kyung Tae Kim, Laguna Niguel, CA (US)

(72) Inventor: Kyung Tae Kim, Laguna Niguel, CA (US)

(21) Appl. No.: 14/147,537

(22) Filed: Jan. 5, 2014

Related U.S. Application Data
(60) Provisional application No. 61/817,303, filed on Apr. 29, 2013.

(51) Int. Cl. H01R 25/00

(52) U.S. Cl. CPC H01R 25/006
USPC 439/650

(57) ABSTRACT

A Shared Ground Multiple Socket (SGMS) sharing a common Ground to save space. In some embodiments a SGMS configured to allow simultaneous utilization of multiple electrical plugs where only one electrical plug utilization was previously possible. In some embodiments, multiple SGMSs configured to fit into a standard size wiring device. In some embodiments, multiple SGMSs configured to fit into a standard size wiring device and further incorporating Tamper Resistant Safety System(s).

### CROSS REFERENCE

This application claims priority to U.S. Provisional 61/817,303 (29 Apr. 2013). This application also cites the following U.S. Patents:

| | Filed: | Issued: | Inventors: |
|---|---|---|---|
| 7,052,299 | 02 FEB. 2005 | 30 MAY 2006 | Kyung T. Kim, Kyung |
| | | | H. Kim |
| 7,198,499 | 04 APR. 2003 | 03 APR. 2007 | Kyung T. Kim, Kyung |
| | | | H. Kim |
| 7,214,079 | 05 APR. 2006 | 08 MAY 2007 | Kyung T. Kim, Kyung |
| | | | H. Kim |
| 7,547,221 | 10 APR. 2007 | 16 JUN. 2009 | Kyung T. Kim, Kyung |
| | | | H. Kim |

### BACKGROUND

Multiple socket receptacles (MSRs) of the cited prior art allow the user to access different circuits. One weakness of these previous MSRs is that their larger size require larger wall cover openings. This necessitates non-standard wall covers with openings larger than the 1.31×2.63 inch National Electrical Manufacturers Association (NEMA) standard.

Another weakness of the aforementioned patents was that in some configurations the MSRs required additional installation labor/wiring to install when compared to regular receptacles.

Yet another weakness of the aforementioned patents was that although the sockets of the MSRs offered multiple circuits, the sockets could only accept one plug at any one time.

### SUMMARY

The objectives of the present invention is to provide features/solutions to the aforementioned weaknesses. The present invention comprises physical dimensions that are compatible with all standard NEMA wall covers and electrical boxes, requires no additional installation labor, and accommodates more than one plug per socket (in some configurations).

Whereas the prior MSRs utilized a shared Neutral, the present invention utilizes a Shared Ground (SG).

### DESCRIPTION OF THE DRAWINGS

Specific embodiments and modifications thereof will become apparent to those skilled in the art from the detailed description herein having reference to following figures, of which:

FIG. 1 is a view of a National Electrical Manufacturers Association (NEMA) 5-15 socket configuration.

FIG. 2 is a view of two NEMA 5-15 sockets being combined.

FIG. 3 is a view of an embodiment of the present invention derived from NEMA 5-15 configuration.

FIG. 10 is a view of a NEMA 5-20 socket configuration.

FIG. 11 is a view of an embodiment of the present invention derived from NEMA 5-20 configuration.

FIGS. 20 and 21 are views of multiple NEMA 5-15 derived configurations of the present invention incorporated into a duplex (dual) receptacle.

FIGS. 30 and 31 are views of multiple NEMA 5-20 derived configurations of the present invention incorporated into a duplex receptacle.

FIG. 40 is a top view of a Hot Terminal 20 of the duplex receptacles of FIGS. 20 and 30.

FIG. 41 is an isometric view of the Hot Terminal of FIG. 40.

FIG. 42 is a flat sheet metal pattern of the Hot Terminal of FIG. 40.

FIG. 50 is an assembled isometric view of all primary sheet metal components of the duplex (dual) receptacles of FIGS. 20 and 30.

FIG. 51 is an exploded isometric view of the sheet metal components FIG. 50.

FIG. 52 is a flat sheet metal pattern 40F of the Ground Terminal 40 of FIG. 51.

FIG. 53 is a flat sheet metal pattern 41F of the Yoke 41 of FIG. 51.

FIG. 54 is a flat sheet metal pattern 42F of one of the Neutral Terminal 42 of FIG. 51.

FIGS. 60, 61, 62, and 63 illustrate alternate NEMA 5-15 derived embodiments.

FIG. 64 is a view of an alternate embodiment multiple NEMA 5-20 derived configuration of the present invention incorporated into a duplex receptacle.

### DETAILED DESCRIPTION

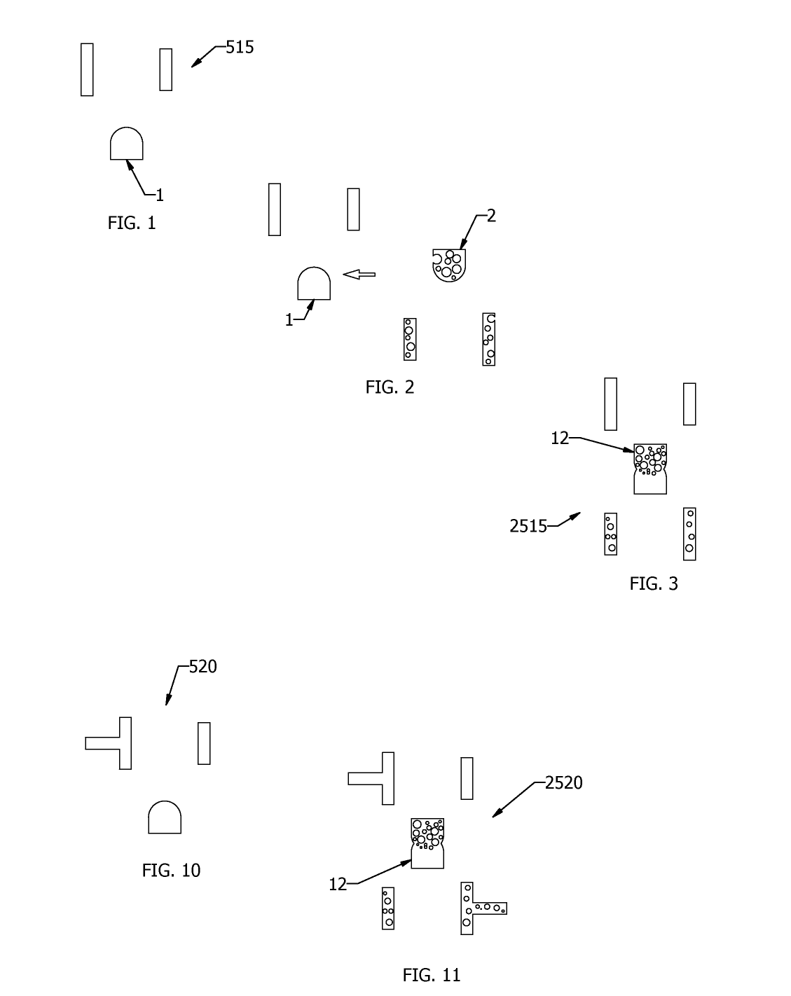

FIG. 1 shows a NEMA 5-15 socket 515 with a standard ground 1. FIG. 2 illustrates an upside-down NEMA 5-15 socket (shown with holes for illustration purposes only) with upside-down ground 2 being combined with another NEMA 5-15 socket with ground 1. FIG. 3 shows a NEMA 5-15 derived Shared Ground Multiple Socket (515SGMS) 2515 embodiment of the present invention. The Shared Ground (SG) 12 is elongated in shape in this embodiment and the 515SGMS 2515 can accept one grounded plug or two non-grounded plugs at any one time.

FIGS. 10 and 11 illustrate NEMA 5-20 socket 520 and NEMA 5-20 derived 520 SGMS 2520 embodiment of the present invention respectively.

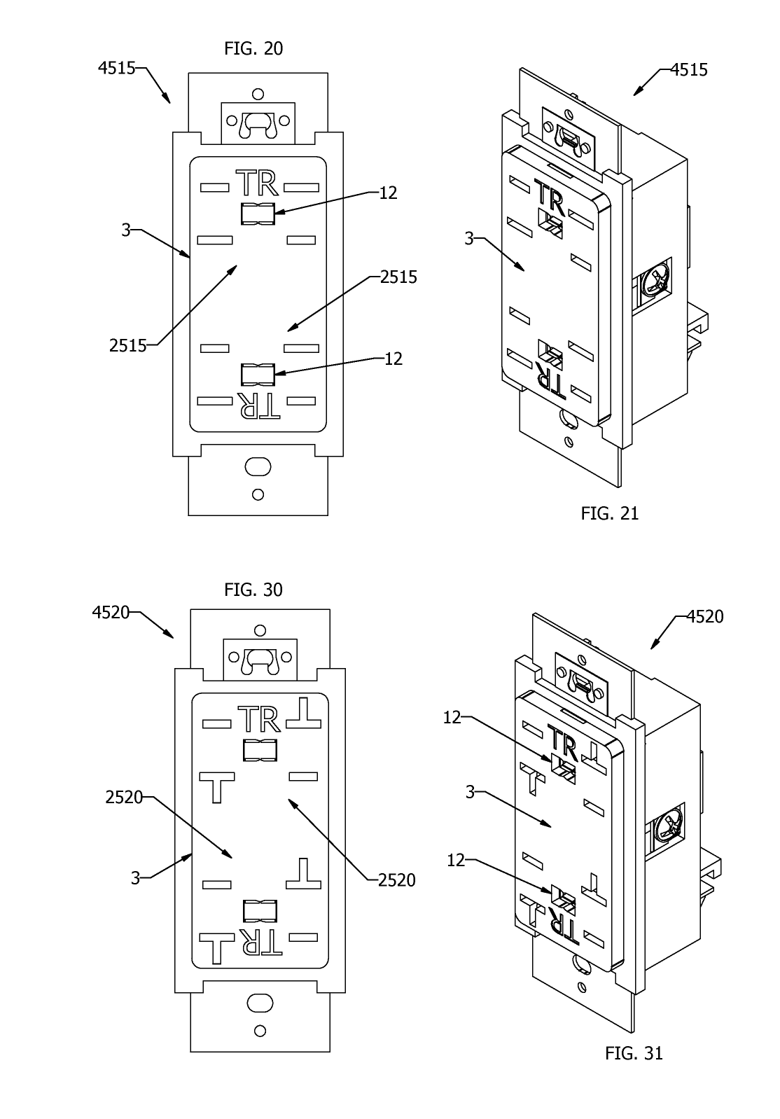

FIGS. 20 and 21 illustrate a NEMA 5-15 Duplex Multiple Socket (MS) Receptacle 4515 utilizing two 515SGMSs 2515 which allow for a standard size NEMA wiring device face 3 (with standard NEMA 1.531 inch spacing between the dual 515SGMSs). With two 515 SGMSs 2515s, this device can accept (at any one time) up to two grounded plugs, up to one grounded plug plus two additional non-grounded plugs, or up to four non-grounded plugs.

FIGS. 30 and 31 illustrate a NEMA 5-20 Duplex MS Receptacle 4520 utilizing two 520 SGMSs 2520.

The invention could be manufactured from industry standard materials (e.g.—plastics, sheet metals, screws, springs, etc.) using industry standard assembly techniques (e.g.—adhesives, screws, nuts/bolts, ultrasonic welding, stakes, etc.).

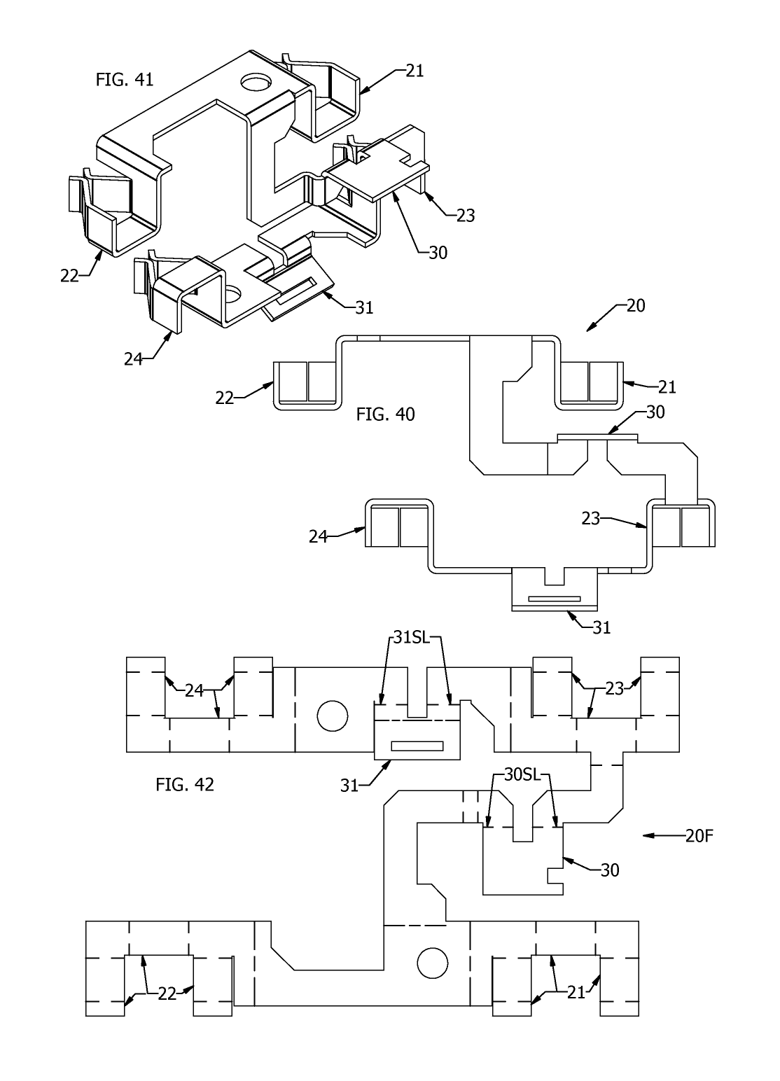

FIGS. 40 and 41 illustrate a Hot Terminal 20 of the NEMA 5-15 Duplex MS Receptacle 4515 or the NEMA 5-20 Duplex MS Receptacle 4520 which is installation labor neutral (i.e.—no additional labor is required for installation when compared to regular duplex receptacles). The Hot Terminal 20 comprises four Hot Contacts 21, 22, 23, 24 and one Half Separator Tab 30 and one Quarter Separator Tab 31.

FIG. 42 illustrates a flat sheet metal pattern 20F of the Hot Terminal 20. Half

Separator Tab 30 could be removed at its Separation Line 30SL to isolate Hot Contacts 21 and 22 from Hot Contacts 23 and 24. Quarter Separator Tab 31 could be removed at its Separation Line 31 SL to isolate Hot Contact 24 from Hot Contacts 21, 22, and 23.

By not removing either Separator Tab 30 or 31 all Hot Contacts 21, 22, 23, 24 communicate with each other and therefore only one electrical connection is required to the Hot Terminal 20 to make all four Hot Contacts active (thus no increase in installation labor when compared to a regular duplex receptacle).

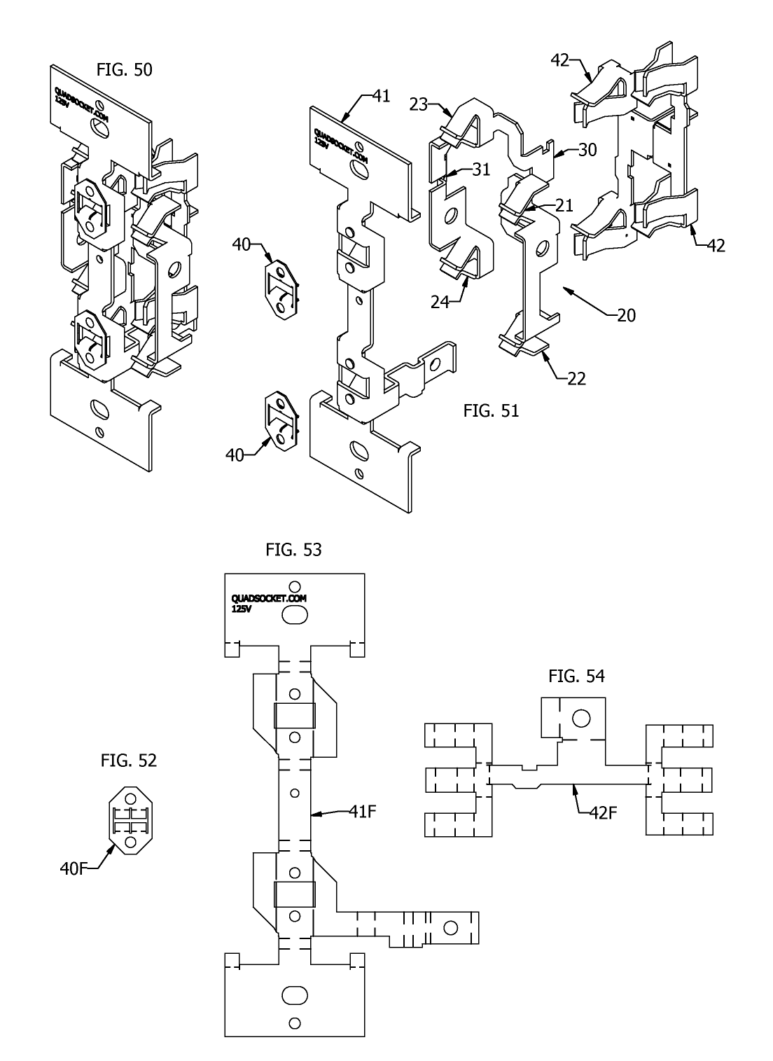

FIGS. 50 through 54 illustrate sheet metal components of the duplex MS receptacles 4515 and 4520. These sheet metal components also allow enough space within the duplex MS receptacles to accommodate Tamper Resistant Systems which provide electrical shock hazard protection.

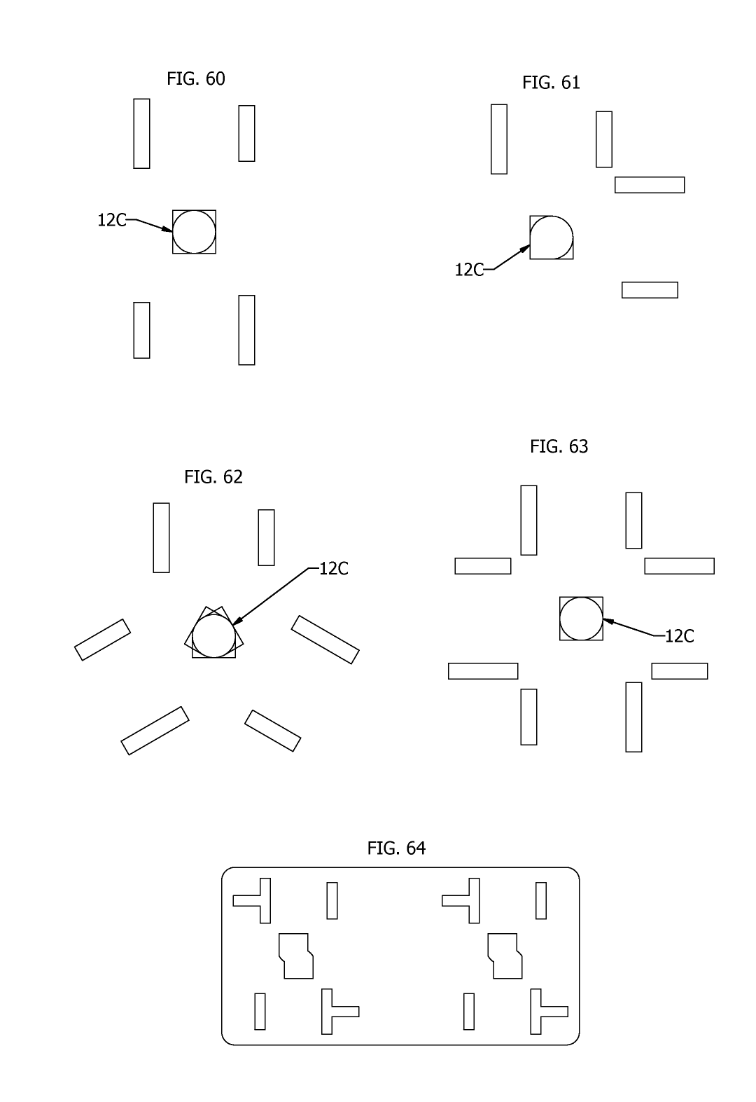

FIG. 60 illustrates an alternate SG embodiment 12C where the axes of the ground apertures are coincident (and thus the SG is non elongated) and sockets are oriented 180 degrees in respect to each other.

FIG. 61 illustrates an alternate embodiment where the sockets are oriented 90 degrees from each other.

FIGS. 62 and 63 illustrate three and four socket embodiments utilizing the coincident SG 12C.

FIG. 64 illustrates an alternate embodiment multiple NEMA 5-20 derived configuration duplex receptacle where the SG is shifted to allow more room for the incorporation of Tamper Resistant Systems around the “T” plug prong aperture.

Alternative embodiments and/or uses of the methods and devices described above and obvious modifications and equivalents thereof are intended to be included within the scope of the present invention.

Although described embodiments show only NEMA socket configurations, the invention could be adapted to any (world wide) socket configuration (AC or DC). Different combinations of socket configurations could be utilized (e.g.—NEMA 5-15 Socket utilizing the same Ground with a NEMA 5-20 Socket).

Additionally, the invention could be incorporated into other than rectangular faced devices (e.g.—devices with multiple island/oval shaped faces).

Alternate embodiment of the duplex MS receptacles (4515, 4520) could incorporate two permanently separated circuits (i.e.—two separate hot terminals and two separate neutral terminals). One hot terminal and one neutral terminal could communicate with the first two of the four sockets while the other hot and neutral terminals could communicate with the last two of the four sockets.

The invention could be adapted into extension cords, powerstrips, current taps, uninterruptible power supplies, etc.

Alternate embodiments could integrate additional safety/convenience/energy saving features (e.g.—GFCI, AFCI, EFCI, circuit breakers, fuses, timer controlled circuitry, occupancy sensor controlled circuitry, automation program controlled circuitry, light sensor controlled circuitry, noise sensor controlled circuitry, etc.).

Thus, it is intended that the scope of the present invention should not be limited by the particular embodiments described above, but should be determined only by a fair reading of the following claims.

1. A Shared Ground Multiple Socket (SGMS) comprising at least two identical or similar electrical sockets;
the electrical sockets configured to share at least one common Ground, and
the electrical sockets comprising electrical plug prong contacts and apertures.

2. The SGMS of claim 1 where at least one of the sockets is a National Electrical Manufacturers Association (NEMA) 5-15 Socket.

3. The SGMS of claim 1 where at least one of the sockets is a NEMA 5-20 Socket.

4. The SGMS of claim 1 configured with at least two of the electrical plug prong contacts in communication with each other.

5. The SGMS of claim 1 configured with at least two of the electrical plug prong contacts in communication with each other, and further configured with at least one means to disrupt communication between at least one of the electrical plug prong contacts from the other(s).

6. A Multiple SGMS Receptacle comprising at least two SGMSs;
each SGMS comprising at least two NEMA 5-15 or 5-20 Sockets, each SGMS configured to share at least one common Ground, and the Sockets comprising electrical plug prong contacts and apertures.

7. Multiple SGMS Receptacle of claim 6 configured to interface with standard NEMA wall covers/coverplates.

8. Multiple SGMS Receptacle of claim 6 configured with at least two of the electrical plug prong contacts in communication with each other.

9. Multiple SGMS Receptacle of claim 6 configured with at least two of the electrical plug prong contacts in communication with each other, and further configured with at least one means to disrupt communication between at least one of the electrical plug prong contacts from the other(s).
